(19) United States
(12) Patent Application Publication
(10) Pub. No.: US 2024/0028976 A1
(43) Pub. Date: Jan. 25, 2024

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Junichi IMOTO, Osaka (JP); Nobuaki TASAKI, Osaka (JP)

(73) Assignee: Panasonic Intellectual Property Corporation of America, Torrance, CA (US)

(21) Appl. No.: 18/376,572

(22) Filed: Oct. 4, 2023

Related U.S. Application Data
(63) Continuation of application No. PCT/JP2022/015711, filed on Mar. 29, 2022.

(30) Foreign Application Priority Data
Apr. 8, 2021 (JP) 2021-065811

(51) Int. Cl. G06N 20/20

(52) U.S. Cl. CPC G06N 20/20

(57) ABSTRACT

A server includes: an acquisition part that acquires and stores article data in a memory; a determination part that calculates an accuracy of a machine learning model which performs machine learning by using the article data stored in the memory, and determines at least one of reduction in data item and reduction in sampling rate so that the calculated accuracy satisfies a reference accuracy; and a transmission part that transmits, to an article, control data for controlling the article to send the article data by using at least one of a data item after the reduction and a sampling rate after the reduction.

### FIELD OF INVENTION

The present disclosure relates to an information processing method for an information processing apparatus connected to one or more articles via a communication network.

### BACKGROUND ART

Patent Literature 1 discloses a method of managing metadata/log information by automatically deleting log information older than those in a last one month when reference to the log information is limited within the past one month.

However, Patent Literature 1 fails to mention reduction in a data amount of article data which is sent from an article and used as learning data, and thus needs further improvement.
Patent Literature 1: Japanese Unexamined Patent Publication No. 2006-318146

### SUMMARY OF THE INVENTION

This disclosure has been achieved to solve the drawbacks described above, and has an object of providing a technology of maintaining an accuracy of a machine learning model which performs machine learning by using article data sent from an article even when a data amount of the article data is reduced.

An information processing method according to one aspect of the present disclosure is an information processing method for an information processing apparatus connected to one or more articles via a communication network. The information processing method includes: acquiring and storing article data in a memory, the article data including a predetermined data item and being sent from the one or more articles at a predetermined sampling rate; calculating an accuracy of a machine learning model which performs machine learning by using the article data stored in the memory when a data amount of the article data stored in the memory is detected to reach a reference data amount or greater, and determining at least one of reduction in data item and reduction in sampling rate so that the calculated accuracy satisfies a reference accuracy; and transmitting, to the one or more articles, control data for controlling the one or more articles to send the article data by using at least one of a data item after the reduction and a sampling rate after the reduction.

This disclosure achieves maintaining of an accuracy of a machine learning model which performs machine learning by using article data sent from an article even when a data amount of the article data is reduced.

### BRIEF DESCRIPTION OF THE DRAWINGS

FIG. 1 is a diagram showing an example of an overall configuration of an information processing system in a first embodiment of the disclosure.

FIG. 2 is a block diagram showing an example of a configuration of an article shown in FIG. 1.

FIG. 3 is a block diagram showing an example of a configuration of a server in the first embodiment of the disclosure.

FIG. 4 is a flowchart showing an example of a process in which the article sends and receives article data in the information processing system in the first embodiment of the disclosure.

FIG. 5 is a flowchart showing an example of a process in which the server transmits control data to the article in the first embodiment of the disclosure.

FIG. 6 is a block diagram showing an example of a configuration of a server in a second embodiment of the disclosure.

FIG. 7 is a flowchart showing an example of a process in which the server transmits control data to an article in the second embodiment of the disclosure.

FIG. 8 is a flowchart showing details of processing of selection.

### DETAILED DESCRIPTION

Knowledge forming the basis of the present disclosure Development of a machine learning model has been considered in recent years for vehicles each including a battery pack to collect battery data from the vehicle to a cloud and estimate a state of the battery through machine learning of the collected battery data.

Here, increasing data items of the battery data to be collected and increasing a sampling rate of the battery data to be collected lead to a success in generating a machine learning model having a high accuracy.

Such an increase in each of the data items and the sampling data causes, however, an increase in a data amount to be stored in a memory on the cloud, resulting in an increase in a management cost of the battery data. The cloud requires conversion of a binary format of the battery data to a predetermined data format to make the battery data available as learning data. This also increases the management cost.

The increase in each of the number of data items and the sampling rate further makes a sending cost of article data too excessive. An unnecessary increase in each of the number of data items and the sampling rate is thus unfavorable.

By contrast, it is necessary to keep a beneficial data item making a large contribution to an increase in the accuracy of the machine learning model.

Aforementioned Patent Literature 1 describes a technology not intended for reduction in a data amount of log information to be acquired, but intended for reduction in a data amount of log information having been acquired, and thus fails to solve the aforementioned drawbacks.

This disclosure has been achieved to solve the drawbacks described above, and has an object of providing a technology of maintaining an accuracy of a machine learning model which performs machine learning by using article data sent from an article even when a data amount of the article data is reduced. Hereinafter, aspects of the disclosure will be described.

An information processing method according to one aspect of the present disclosure is an information processing method for an information processing apparatus connected to one or more articles via a communication network. The information processing method includes: acquiring and storing article data in a memory, the article data including a predetermined data item and being sent from the one or more articles at a predetermined sampling rate; calculating an accuracy of a machine learning model which performs machine learning by using the article data stored in the memory when a data amount of the article data stored in the memory is detected to reach a reference data amount or greater, and determining at least one of reduction in data item and reduction in sampling rate so that the calculated accuracy satisfies a reference accuracy; and transmitting, to the one or more articles, control data for controlling the one or more articles to send the article data by using at least one of a data item after the reduction and a sampling rate after the reduction.

According to this configuration, at least one of reduction in data item and reduction in sampling rate is determined so that the accuracy of the machine learning model using the article data as learning data satisfies the reference accuracy, and the control data for controlling the sending of the article data in use of at least one of a data item after the reduction and a sampling rate after the reduction is sent to the article. This achieves maintaining of the accuracy of the machine learning model which performs the machine learning by using the article data sent from the article even when a data amount of the article data is reduced.

In the information processing method, the predetermined data item may include a plurality of data items, and, in the determining, a priority rank of each of the data items may be acquired, and one or more candidate data items may be determined in descending priority order as remaining data items.

According to this configuration, the priority rank of each of the data items is acquired, and one or more candidate data items are determined in the descending priority order as remaining data items. This enables determination of reduction in data item while maintaining a data item having a higher priority rank.

In the information processing method, in the determining, a minimum sampling rate at which the accuracy satisfies the reference accuracy may be calculated as a candidate sampling rate for each of the candidate data items, one or more sets each including a candidate sampling rate and a candidate data item corresponding to the candidate sampling rate may be generated, and the candidate sampling rate and the candidate data item included in a set having a minimum data amount among the sets may be respectively determined as the sampling rate after the reduction and the data item after the reduction.

According to this configuration, the minimum sampling rate at which the accuracy of the machine learning model satisfies the reference accuracy is calculated as a candidate sampling rate for each of the candidate data items, one or more sets each including a certain candidate sampling rate and a certain candidate data item corresponding to the certain candidate sampling rate are generated, and a specific candidate sampling rate and a specific candidate data item included in the set having the minimum data amount among the sets are respectively determined as the sampling rate after the reduction and the data item after the reduction. This achieves accurate determination of the sampling rate after the reduction and the data item after the reduction.

In the information processing method, the priority rank may be calculated on the basis of importance of each of the data items calculated in the machine learning of the article data stored in the memory, the machine learning adopting a predetermined machine learning algorithm.

According to this configuration, the priority rank is determined on the basis of importance of each of the data items calculated in the machine learning of the article data stored in the memory, the machine learning adopting the predetermined machine learning algorithm. This facilitates determination of the priority rank of each of the data items.

In the information processing method, the machine learning algorithm may include a random forest.

This configuration facilitates determination of the priority rank by using the already-existing machine learning algorithm called the random forest.

In the information processing method, each of the candidate data items may include one or more data items combined in the descending priority order.

According to this configuration, each of the candidate data items includes one ore more data items combined in the descending priority order, and thus, the configuration achieves preferential maintaining of a data item having a higher rank.

The information processing method may further include: selecting each of the articles as a first article satisfying a predetermined selection reference or as a second article dissatisfying the predetermined selection reference; and, in the transmitting of the control data, transmitting the control data to the second article without transmitting the control data to the first article.

According to this configuration, at least one of the data item after the reduction and the sampling rate after the reduction is applied only to the second article dissatisfying the selection reference. This attains acquisition of article data mainly from the first article maintaining at least one of a certain data item before the reduction and a certain sampling rate before the reduction, and enables effective collection of article data necessary for generating a machine learning model having a high accuracy.

In the information processing method, in the selecting, a selection score may be calculated for each of the articles on the basis of the article data stored in the memory, and an article having a selection score of a selection reference value or higher may be selected as the first article.

According to this configuration, an article having a selection score of a selection reference value or higher is selected as the first article, the selection score being calculated on the basis of the article data. This enables selection of each of the first article and the second article in consideration of contents of the article data sent from each of the articles.

In the information processing method, the selection reference value may correspond to a proportion of the first article to the first article and the second article, the proportion being a maximum proportion to allow a learning cost to be a reference learning cost or lower in the machine learning of the article data sent from the first article and the second article.

According to this configuration, each of the first article and the second article is selected on the basis of the maximum proportion allowing the learning cost to be the reference learning cost or lower in the machine learning of the article data sent from the first article and the second article. This succeeds in maximizing the proportion of the first article as far as the learning cost does not exceed the reference learning cost.

In the information processing method, the selection score may have a value corresponding to a sending frequency of the article data.

According to this configuration, an article having a high sending frequency of the article data is selected as the first article, and thus, the configuration attains acquisition of the article data mainly from the article having the high sending frequency of the article data, and enables effective collection of the article data necessary for generating the machine learning model having the high accuracy.

In the information processing method, the article may include a battery, and the selection score may have a value corresponding to at least one of a sending frequency of the article data, a use frequency of the battery, a discharge range of the battery, and an acquisition frequency of an open circuit voltage of the battery.

According to this configuration, an article having a high sending frequency of the article data, a high use frequency of the battery, a wide discharge range of the battery, and a high acquisition frequency of the open circuit voltage of the battery is selected as the first article, and thus, the configuration attains acquisition of the article data mainly from this article, and enables effective collection of the article data necessary for generating the machine learning model having the high accuracy.

In the information processing method, the article data may include data about the battery included in the article.

This configuration enables generation of a machine learning model related to the battery.

An information processing apparatus according to another aspect of the present disclosure is an information processing apparatus connected to one or more articles via a communication network. The information processing apparatus includes: an acquisition part that acquires and stores article data in a memory, the article data including a predetermined data item and being sent from the one or more articles at a predetermined sampling rate; a determination part that calculates an accuracy of a machine learning model which performs machine learning by using the article data stored in the memory when a data amount of the article data stored in the memory is detected to reach a reference data amount or greater, and determines at least one of reduction in data item and reduction in sampling rate so that the calculated accuracy satisfies reference accuracy; and a transmission part that transmits, to the one or more articles, control data for controlling the one or more articles to send the article data by using at least one of a data item after the reduction and a sampling rate after the reduction.

With this configuration, it is possible to provide an information processing apparatus that exerts the operational effects of the information processing method described above.

An information processing program according to still another aspect of the disclosure is an information processing program for causing a computer to serve as an information processing apparatus connected to one or more articles via a communication network. The information processing program includes: causing a processor included in the information processing apparatus to execute: acquiring and storing article data in a memory, the article data including a predetermined data item and being sent from the one or more articles at a predetermined sampling rate; calculating an accuracy of a machine learning model which performs machine learning by using the article data stored in the memory when a data amount of the article data stored in the memory is detected to reach a reference data amount or greater, and determining at least one of reduction in data item and reduction in sampling rate so that the calculated accuracy satisfies a reference accuracy; and transmitting, to the one or more articles, control data for controlling the one or more articles to send the article data by using at least one of a data item after the reduction and a sampling rate after the reduction.

With this configuration, it is possible to provide an information processing program that exerts the operational effects of the information processing method described above.

This disclosure can be realized as an information processing system caused to operate by the information processing program as well. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

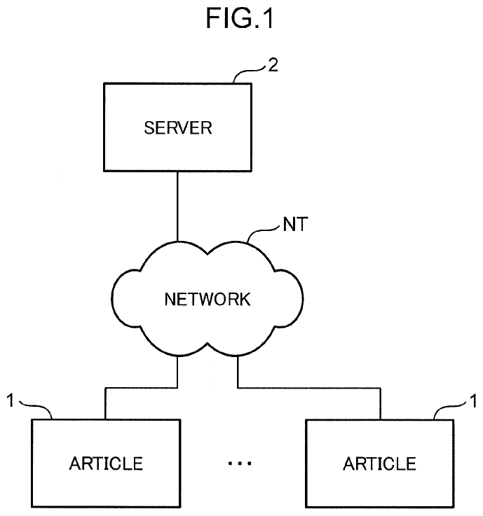

FIG. 1 is a diagram showing an example of an overall configuration of an information processing system in a first embodiment of the disclosure. The information processing system includes one or more articles 1 and a server 2. The articles 1 and the server 2 are communicably connected to each other via a network NT. The network NT includes, for example, a wide area network having an internet communication network, a mobile phone communication network, and a satellite communication network.

Each article 1 sends article data to the server 2. Examples of the article 1 include an electric vehicle, an electric bicycle, an electric scooter, and other vehicle. However, this is a mere example, and the article 1 may include an electric home appliance, e.g., a refrigerator, a washing machine, a microwave oven, an oven, a television, an audio appliance, and other appliance. Alternatively, the article 1 may be an automobile driven by an engine. Examples of the electric vehicle may include a plug-in hybrid automobile without limitation to an automobile driven solely by an electric motor.

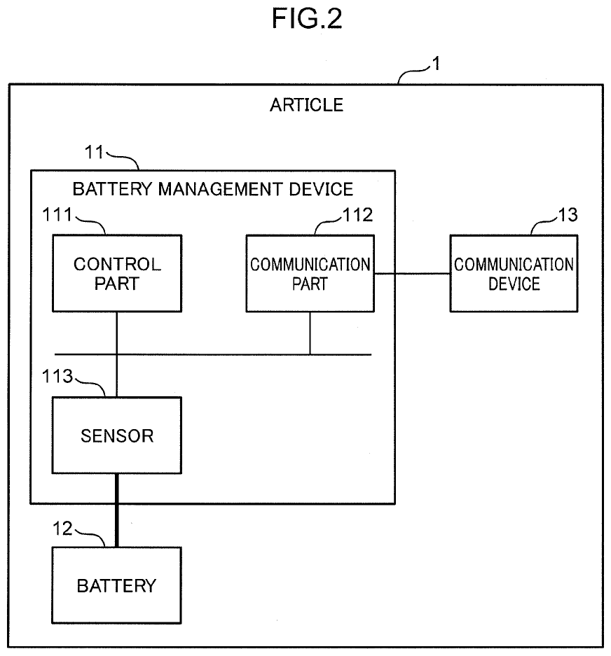

The article 1 may further include a battery management device 11 (see FIG. 2) constituting the electric vehicle. The battery management device 11 manages a battery included in the electric vehicle.

The server 2 includes, for example, a cloud server including one or more computers. The server 2 acquires the article data sent from the article 1. The server 2 transmits, to the article 1, control data intended for the article 1. The control data represents software allowing a processor included in the article 1 to control the article 1, and corresponds to, for example, firmware. In the embodiment, the control data includes: information designating a sampling rate of the article data to be sent from the article 1 to the server 2; and information designating a data item of the article data to be sent from the article 1 to the server 2. The article 1 may include a function of receiving the control data through a wireless called “OTA”, i.e., over the air.

The article data includes one or more data items. In a case where the article 1 is an electric vehicle, examples of the data items include: a discharging voltage; a charging voltage; a discharging electric current; a charging electric current; a temperature of the battery; state information about the battery; error information; a state of charge (SOC); a state of health (SOH); and an open circuit voltage (OCV). The state information about the battery includes information indicating a current state of the battery, e.g., a state of charge and a state of discharge. However, this is a mere example, and in a case where the article 1 is a vehicle, examples of the data item may include: an acceleration rate of the vehicle; GPS information indicating a position of the vehicle; and an angular velocity of the vehicle. Alternatively, in a case where the article 1 is an electric appliance, the article data may include operational data of the electric appliance. The operational data may include, for example, an operational mode, a set temperature, power-on information, and power-off information about the electric appliance. The article data further includes a time stamp showing a date and time of generation of the article data and an article ID or identifier of the article 1 serving as a sending source, in addition to the data item.

Hereinafter, the article 1 is described as an electric vehicle, and the article data is described to include data items related to a battery, such as, a discharging voltage, a charging voltage, a discharging electric current, a charging electric current, a temperature of a battery, state information about the battery, error information, an SOC, an SOH, and an open circuit voltage. However, this disclosure is not limited thereto.

FIG. 2 is a block diagram showing an example of a configuration of the article 1 shown in FIG. 1. The article 1 is, for example, an electric vehicle. The article 1 includes the battery management device 11, a battery 12, and a communication device 13. The battery management device 11 manages the battery 12. The battery management device 11 has a control part 111, a communication part 112, and a sensor 113.

The control part 111 includes a processor, such as a central processing unit, and executes control data to control the battery 12. The control part 111 generates article data including a data item designated by control data at a sampling rate designated by the control data. Initial control data which has not been updated includes information designating all the data items among data items predetermined as sendable to the server 2. The initial control data further includes information designating a maximum sampling rate among presumable sampling rates at which the server 2 and the article 1 are communicable with each other. The sampling rate stands for a sending frequency of the article data per unit time, and is expressed by a reciprocal of a sending cycle (sampling cycle) of the article data.

The control part 111 may generate the article data by using, for example, sensing data including a detection value detected by the sensor 113. The control part 111 inputs the generated article data to the communication device 13 by using the communication part 112. The control part 111 may generate the SOC, the SOH, and the state information by using the sensing data. The control part 111 may acquire the OCV by causing a voltage sensor to detect the open circuit voltage of the battery 12 after a lapse of a predetermined time from a pose state where the battery 12 is neither charged nor discharged. The predetermined time includes, for example, two hours, four hours, or the like.

The communication part 112 includes a communication circuit corresponding to an in-vehicle network, e.g., a CAN (controller Area Network), and inputs the article data generated by the control part 111 to the communication device 13 via the in-vehicle network.

Examples of the sensor 113 include an electric current sensor, a voltage sensor, and a temperature sensor. The electric current sensor detects a discharging electric current and a charging electric current of the battery 12. The voltage sensor detects a discharging voltage and a charging voltage of the battery 12. The temperature sensor detects a temperature of the battery 12.

The battery 12 is a chargeable secondary battery, e.g., a lithium-ion battery and a nickel-metal hydride battery.

The communication device 13 is configured to connect the article 1 to the network NT through a wireless communication, e.g., the BLE (Blue tooth Low Energy). The communication device 13 acquires the article data generated by the control part 111 via the communication part 112, and transmits the acquired article data to the server 2. In this way, the article 1 can send the article data to the server 2 at a predetermined sampling rate.

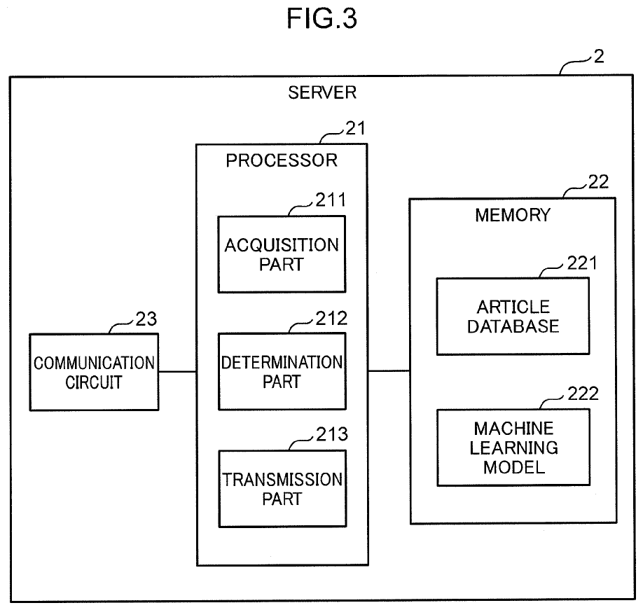

FIG. 3 is a block diagram showing an example of a configuration of the server 2 in the first embodiment of the disclosure. The server 2 includes a processor 21, a memory 22, and a communication circuit 23. The processor 21 includes, for example, a central processing unit, and has an acquisition part 211, a determination part 212, and a transmission part 213. The processor 21 executes an information processing program stored in the memory 22 to realize the acquisition part 211 to the transmission part 213. Each of the acquisition part 211 to the transmission part 213 may be formed of a dedicated electric circuit.

The acquisition part 211 acquires and stores the article data in an article database 221 included in the memory 22, the article data including a predetermined data item and being sent from the article 1 at a predetermined sampling rate via the communication circuit 23. The predetermined data item is designated by the control data for the article 1. The predetermined sampling rate is designated by the control data for the article 1. The article data has a binary-format, and thus, a machine learning model 222 cannot distinguish a data item. The acquisition part 211 here inputs the article data into a predetermined conversion formula to convert the data format of the article data to a data format with which the machine learning model 222 can identify a data item. The acquisition part 211 then stores, in the article database 221, the article data having the converted data format.

The determination part 212 detects whether a data amount of the article data stored in the article database 221 reaches a reference data amount or greater. The reference data amount indicates, for example, a data amount predetermined suitably for allowing the machine learning model 222 to perform machine learning using the article data.

When the data amount of the article data is detected to reach the reference data amount or greater, the determination part 212 calculates an accuracy of the machine learning model 222 which performs the machine learning by using the article data stored in the article database 221. The determination part 212 determines reduction in data item and reduction in sampling rate so that the calculated accuracy satisfies a reference accuracy.

For instance, the determination part 212 may cause the machine learning model 222 to execute machine learning defining a predetermined data item as input data and defining another predetermined data item as output data or training data among data items constituting the article data. The training data includes, for example, the SOC, the SOH, and the error information.

The determination part 212 may calculate the accuracy of the machine learning model 222 by, for example, employing a validation way of: classifying datasets into a learning dataset and a validation dataset; causing the machine learning model 222 to perform machine learning by using the learning dataset; and calculating the accuracy of the machine learning model 222 by using the validation dataset. For instance, cross-validation or hold-out validation is employable as the validation way. Adoptable examples of the cross-validation include a K=fold cross-validation and LOOCV (leave out cross validation). The accuracy may adopt, for example, a coefficient of determination, a root mean square error, and a mean absolute error for a regression model, and may adopt an accuracy rate and a precision rate for a classification model.

The reference accuracy takes a predetermined value. For instance, in a case where the accuracy takes a value of a low accuracy like the root mean square error, the determination part 212 may determine that the value satisfies the reference accuracy when the value is equal to or lower than the reference accuracy. Alternatively, in a case where the accuracy takes a value indicating a high accuracy like the accuracy rate, the determination part 212 may determine that the value satisfies the reference accuracy when the value is equal to or higher than the reference accuracy.

The determination part 212 determines a priority rank of each of the data items, and determines one or more candidate data items in descending priority order as remaining data items. The determination part 212 may calculate the priority rank of each of the data items on the basis of importance of each of the data items calculated in the machine learning of the article data stored in the article database 221, the machine leaning adopting a predetermined machine learning algorithm. A random forest is adoptable as the predetermined machine learning algorithm. However, this is a mere example, and another machine learning algorithm may be adopted in place of the random forest as long as the machine learning algorithm is available for calculating the importance. For instance, the determination part 212 may determine the priority rank of each of the data items in descending importance order of the data items. In the embodiment, the machine learning model 222 indicates the random forest. The determination part 212 hence can acquire the importance of each of the data items by causing the machine learning model 222 to perform the machine learning of the article data. Each data item whose priority rank and importance is calculated represents a data item except for a data item determined as training data among article data. When the memory 22 stores setting information on the priority rank of each data item in advance, the determination part 212 may determine the priority rank of each data item by acquiring the setting information from the memory 22.

The determination part 212 may generate one or more candidate data items by combining one or more data items in the descending priority order.

The determination part 212 calculates a minimum sampling rate at which the accuracy satisfies the reference accuracy as a candidate sampling rate for each of the candidate data items, and generates one or more sets each including a candidate sampling rate and a candidate data item corresponding to the certain candidate sampling rate. The determination part 212 having generated the sets may determine the specific candidate sampling rate and the specific candidate data item included in a set having a minimum data amount among the sets respectively as the sampling rate after the reduction and the data item after reduction. The data item after the reduction stands for a data item to be maintained. Hereinafter, the sampling rate after the reduction is called an optimal sampling rate, and the data item after the reduction is called an optimal data item.

The transmission part 213 transmits, to the article 1, the control data for causing the article 1 to send the article data by using the optimal data item at the optimal sampling rate.

The memory 22 includes a non-volatile and rewritable storage device, such as a solid state drive and a hard disk drive, and stores the article database 221 and the machine learning model 222. The article database 221 stores the article data sent from the article 1. The article database 221 is a database where one record is allotted to one piece of article data. The record stores a value of a data item belonging to the article data, a time stamp showing a date and time of generation of the article data, and an article ID of the article 1 serving as a sending source in association with one another.

The determination part 212 uses the machine learning model 222 to calculate an optimal data item, an optimal sampling rate, and importance. The random forest is adoptable as the machine learning model 222. However, this is a mere example, and another machine learning model may be adopted in place of the random forest.

The machine learning model 222 is just a machine learning model that is used to calculate the optimal data item, the optimal sampling rate, and the importance, and thus differs from a purpose machine learning model in a practical use scene. Such a purpose machine learning model is generated through machine learning of an enormous amount of article data as learning data, the article data being sent from the article 1 which executes the control data generated in the embodiment. The generated purpose machine learning model is downloaded to the article 1 or an external server, and used by the article 1 or the external server to calculate predetermined output data, such as the SOC and the SOH.

However, this is a mere example, and the machine learning model 222 may serve as the purpose machine learning model. Alternatively, a machine learning model that is used to calculate the optimal data item and the optimal sampling rate and a machine learning model that is used to calculate the importance may differ from each other.

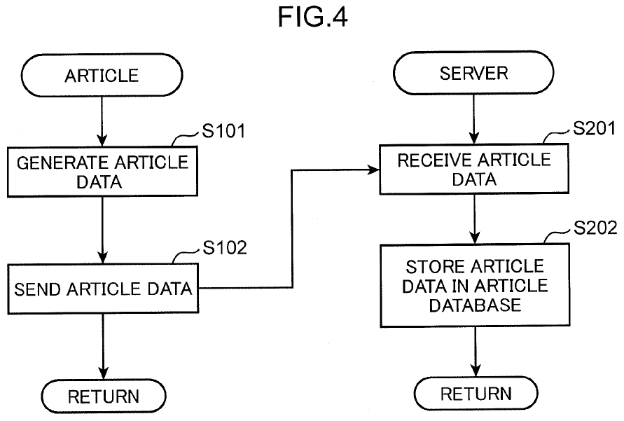

Heretofore, the configuration of the information processing system is described. Hereinafter, an operation of the information processing system will be described. FIG. 4 is a flowchart showing an example of a process in which the article 1 sends and receives article data in the information processing system in the first embodiment of the disclosure.

In step S101, the control part 111 of the article 1 generates article data by using sensing data from the sensor 113. In step S102, the control part 111 sends the generated article data to the server 2 via the communication part 112 and the communication device 13.

In step S201, the acquisition part 211 of the server 2 acquires the article data by using the communication circuit 23. In step S202, the acquisition part 211 inputs the article data into a predetermined conversion formula to convert the data format of the article data to a data format for allowing the machine learning model 222 to identify a data item, an article ID, and a time stamp, and stores the article data having the converted format in the article database 221.

The article 1 and the server 2 repeat their respective steps shown in FIG. 4 at a sampling rate designated by the control data. In this manner, the article database 221 stores the control data.

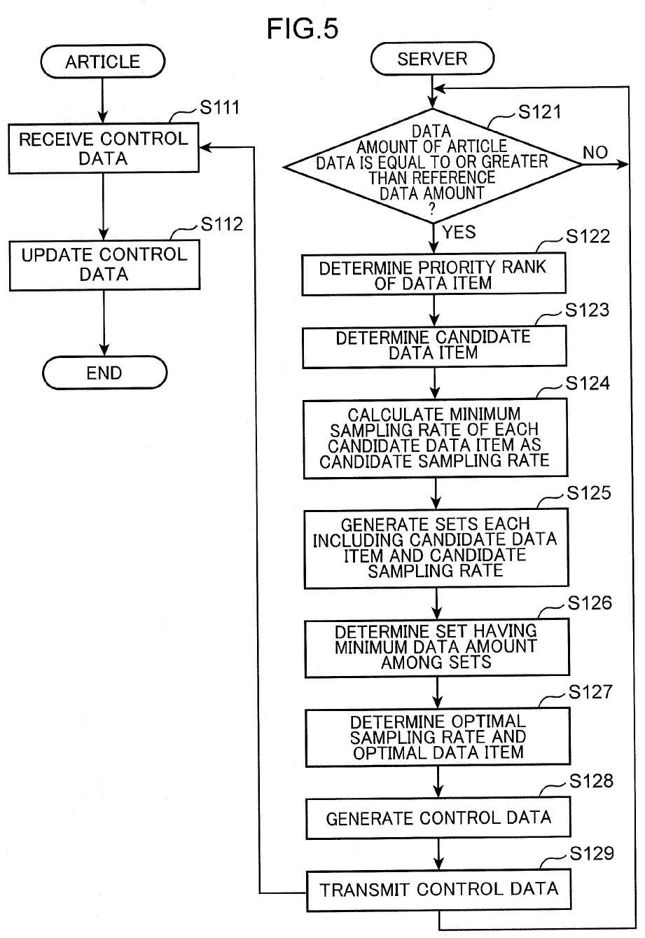

FIG. 5 is a flowchart showing an example of a process in which the server 2 transmits control data to the article 1 in the first embodiment of the disclosure.

In step S121, the acquisition part 211 determines whether a data amount of the article data stored in the article database 221 is equal to or greater than a reference data amount. When the data amount of the article data is equal to or greater than the reference data amount (YES in step S121), the process proceeds to step S122. When the data amount of the article data is smaller than the reference data amount, the process stays in step S121 in standby. In a case where an optimal data item and an optimal sampling rate have been already determined, the data amount of the article data to be compared with the reference data amount corresponds to a data amount of article data stored in the article database 221 from previous determination of the optimal data item and the optimal sampling rate. By contrast, in a case where neither optimal data item nor optimal sampling rate has been ever determined, a data amount of the article data to be compared with the reference data amount corresponds to a data amount of all the article data stored in the article database 221.

In step S122, the determination part 212 determines a priority rank of each of data items constituting the article data. The determination part 212 here may calculate importance of each of the data items and determine a priority rank of each of the data items in descending order of the calculated importance by reading out article data to be learned from the article database 221 and causing the machine learning model 222 to perform machine learning of the read-out article data as learning data. For instance, in the case where the optimal data item and the optimal sampling rate have been already determined, the article data to be learned corresponds to article data stored in the article database 221 in a period from previous determination of the optimal data item and the optimal sampling rate to determination “YES” in step S121. By contrast, in the case where neither optimal data item nor optimal sampling rate has been ever determined, the article data to be learned corresponds to all the article data stored in the article database 221 in a period to the determination “YES” in step S121.

In step S123, the determination part 212 generates one or more candidate data items by combining one or more data items in the descending priority order. For instance, three data items A1 to A3 serve as data items, and the data items A1 to A3 respectively have higher priority ranks in this order. In this case, the determination part 212 may generate each candidate data item including more data items having higher priority ranks in such a manner that: a candidate data item including the data item A1 is defined as a candidate data item B1 having a first priority rank; a candidate data item including the data item A1 and the data item A2 is defined as a candidate data item B2 having a second priority rank; and a candidate data item including the data item A1, the data item A2, and the data item A3 is defined as a candidate data item B3 having a third priority rank. Hereinafter, generation of the candidate data items B1 to B3 is described as an example, but this disclosure is not limited thereto. For example, the number of candidate data items may take an appropriate numeral value, such as, five, ten, and twenty.

In step S124, the determination part 212 calculates, as a candidate sampling rate, a minimum sampling rate at which an accuracy of each of candidate data items B1 to B3 satisfies a reference accuracy. Specifically, the determination part 212 calculates a candidate sampling rate in the following manner.

First, the determination part 212 sets a predetermined minimum sampling rate, and reads out, from the article database 221, article data corresponding to the set sampling rate and including the candidate data item B1 and a data item (e.g., SOC) serving as training data. Next, the determination part 212 causes the machine learning model 222 to perform machine learning of the read-out article data as learning data, and calculates an accuracy of the machine learning model 222 after the machine learning. Subsequently, the determination part 212 determines whether the calculated accuracy satisfies the reference accuracy, and increases the sampling rate by a predetermined resolution when the calculated accuracy dissatisfies the reference accuracy. The determination part 212 then reads out, from the article database 221, article data corresponding to the increased sampling rate and including the candidate data item B1 and a data item (e.g., SOC) serving as training data. Further, the determination part 212 causes the machine learning model 222 to perform machine learning of the read-out article data as learning data, and calculates an accuracy of the machine learning model 222 after the machine learning. The determination part 212 repeats the sequence for the candidate data item B1 until the accuracy of the machine learning model 222 satisfies the reference accuracy, and calculates a sampling rate at which the accuracy satisfies the reference accuracy as the minimum sampling rate for the candidate data item B1.

The determination part 212 calculates minimum sampling rates respectively for the candidate data items B2 and B3 by applying the same sequence as the sequence for the candidate data item B1 to these items. The determination part 212 then calculates the minimum sampling rates respectively calculated for the candidate data items B1, B2, and B3 as candidate sampling rates R1, R2, and R3 for the candidate data items B1, B2, and B3.

In step S125, the determination part 212 generates a set M1 including the candidate data item B1 and the candidate sampling rate R1, a set M2 including the candidate data item B2 and the candidate sampling rate R2, and a set M3 including the candidate data item B3 and the candidate sampling rate R3.

In step S126, the determination part 212 determines a set having a minimum data amount among the sets M1 to M3. For instance, the determination part 212 may calculate, as a data amount of the set M1, a data amount (a bit number or a byte number) of the candidate data item B1 at the candidate sampling rate R1 per unit time. Moreover, the determination part 212 may calculate the data amount in each of the sets M2 and M3 in the same manner as in the set M1.

When the number of data items is small, it is necessary to set a high sampling rate. Otherwise, the accuracy of the machine learning model 222 fails to reach the reference accuracy or higher. By contrast, when the number of data items is large, the accuracy of the machine learning model 222 can reach the reference accuracy or higher even at a low sampling rate. It is seen from this perspective that the number of data items and the sampling rate are in a trade-off relationship. In the embodiment, not the bit number of the candidate data item is simply used to evaluate the sets M1 to M3, but a data amount of each of the sets M1 to M3 per unit time is used to evaluate the sets M1 to M3.

The trade-off relationship between the sampling rate and the number of candidate data items may keep the accuracy of the machine learning model 222 from reaching the reference accuracy or higher even at a maximum sampling rate concerning the candidate item having fewer data items. In this case, the determination part 212 may exclude the candidate data item whose accuracy fails to reach the reference accuracy or higher from determinable optimal data item candidates.

In step S127, the determination part 212 determines a specific candidate sampling rate and a specific candidate data item constituting a set having a minimum data amount as an optimal sampling rate and an optimal data item. For instance, when the set M2 has the minimum data amount, each of the data items A1 and A2 constituting the candidate data item B2 is determined as the optimal data item, and the candidate sampling rate R2 is determined as the optimal sampling rate.

In step S128, the determination part 212 generates control data for causing the article 1 to send article data having the optimal data item at the optimal sampling rate. In step S129, the transmission part 213 transmits the generated control data to the article 1 by using the communication circuit 23.

In step S111, the communication device 13 of the article 1 receives the control data. In step S112, the control part 111 of the article 1 acquires the control data via the communication part 112, and updates current control data by using the acquired control data. In this way, the optimal sampling rate and the optimal data item are set for the article 1. Thereafter, the article 1 sends the article data having the optimal data item to the server 2 at the optimal sampling rate.

Conclusively, according to the first embodiment, each of reduction in data item and reduction in sampling rate is determinable so that an accuracy of the machine learning model 222 using article data as learning data satisfies a reference accuracy, and control data for sending the article data having a data item or optimal data item after the reduction is transmitted to the article 1 at a sampling rate or optimal sampling rate after the reduction. This attains reduction in a data amount of the article data while maintaining the accuracy of the machine learning model in use of the control data transmitted from the article 1 as learning data for the machine learning model.

### Second Embodiment

A second embodiment aims at updating control data for only an article 1 which dissatisfies a selection reference.

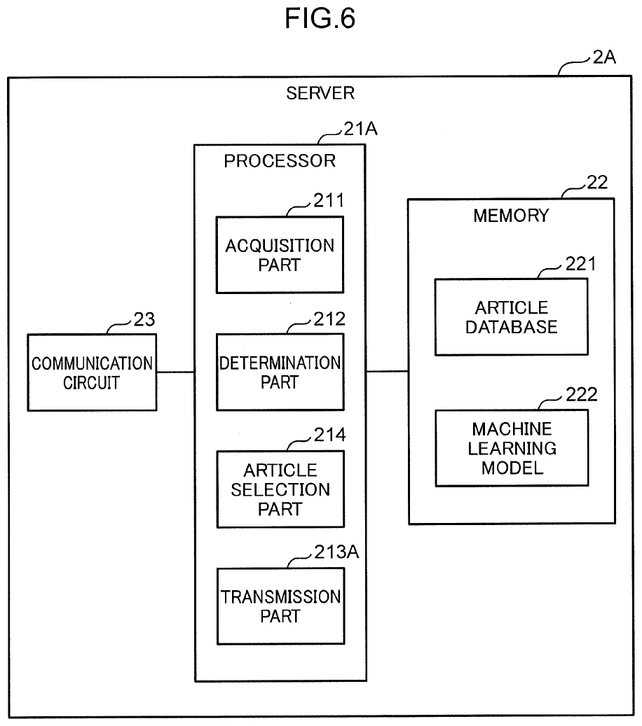

FIG. 6 is a block diagram showing an example of a configuration of a server 2 in the second embodiment of the disclosure. In the second embodiment, constituent elements which are the same as those in the first embodiment are given the same reference numerals and signs, and thus explanation therefor will be omitted. A processor 21A included in the server 2A has an acquisition part 211, a determination part 212, an article selection part 214, and a transmission part 213A.

The article selection part 214 selects each of articles 1 as a first article satisfying a selection reference or a second article dissatisfying a selection reference.

The article selection part 214 calculates a selection score for each of the articles 1 on the basis of article data stored in an article database 221, and determines an article 1 having a selection score of a selection reference value or higher as the first article.

Here, the selection reference value corresponds to a proportion of the first article to the first article and the second article. This proportion is a maximum proportion to allow a learning cost to be a reference learning cost or lower in machine learning of the article data sent from the first article and the second article. The learning cost has, for example, an estimative value of the cost occurring in the machine learning by the aforementioned purpose machine learning model. Specifically, the learning cost includes an estimation cost, an estimative expense cost, or an average estimative cost of the estimation cost and the estimative expense cost. For instance, the article selection part 214 may calculate the data amount of the article data to be used in the machine learning, and calculate the learning cost by inputting the data amount into a predetermined conversion formula. The reference learning cost has, for example, a predetermined upper limit value of a permissible learning cost.

The selection score has a value corresponding to at least one of a sending frequency of the article data, a use frequency of a battery 12, a discharge range of the battery 12, and an acquisition frequency of an open circuit voltage of the battery 12.

Use of article data from the article 1 having a high sending frequency of the article data increases the possibility of obtaining a purpose machine learning model having a high accuracy. In the embodiment, with an aim of mainly acquiring article data from an article 1 having a high sending frequency of the article data, the article 1 is selected as the first article. From the same perspective, in the embodiment, with an aim of mainly acquiring article data from an article 1 having at least one of a high use frequency of the battery 12, a wide discharge range of the battery 12, and a high acquisition frequency of the open circuit voltage of the battery 12, the article 1 is selected as the first article.

The transmission part 213A transmits the control data to the second article without transmitting the control data to the first article.

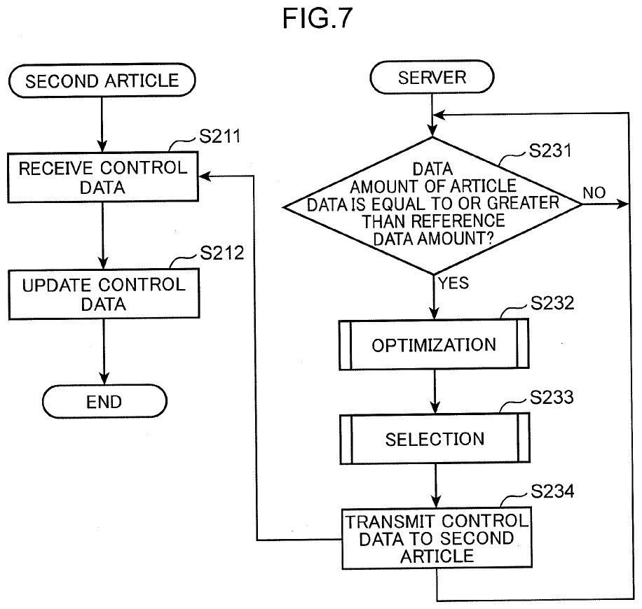

FIG. 7 is a flowchart showing an example of a process in which the server 2 transmits the control data to the article 1 in the second embodiment of the disclosure. Step S231 is the same as step S121 in FIG. 5. In step S232, the determination part 212 performs optimization for determining an optimal data item and an optimal sampling rate. The optimization includes steps S122 to S128 shown in FIG. 5, and hence, explanation therefor is omitted.

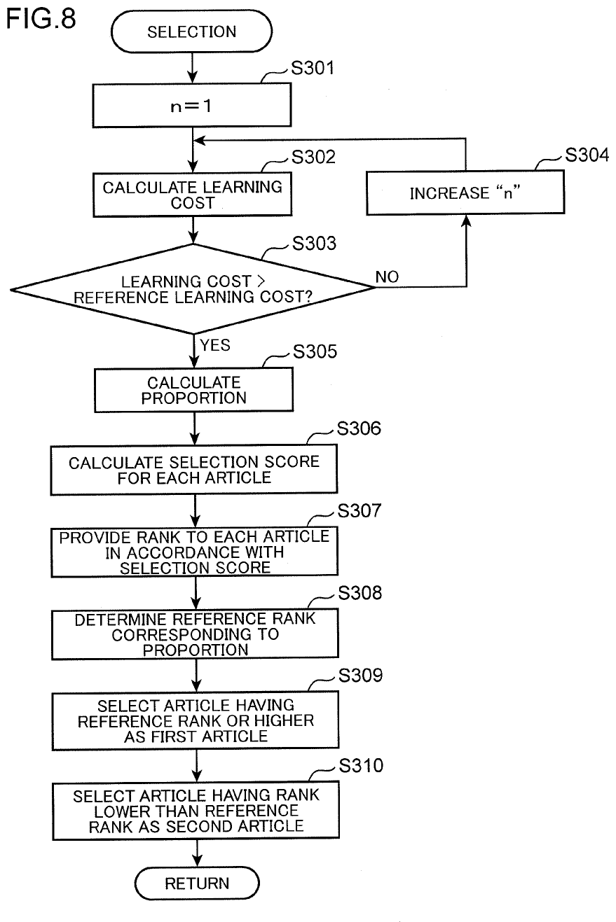

In step S233, the article selection part 214 executes selection. Processing of the selection will be described in detail later with reference to FIG. 8.

In step S234, the transmission part 213A transmits control data for causing the second article selected in the selection to send article data having an optimal data item at an optimal sampling rate.

In step S211, a communication device 13 included in the second article receives the control data. In step S212, a communication part 112 included in the second article acquires the control data via the communication device 13, and updates current control data by using the acquired control data. In this way, an optimal sampling rate and an optimal data item are set for the second article. Thereafter, the second article sends the article data having the optimal data item to the server 2 at the optimal sampling rate. The control data is not transmitted to the first article, and therefore, the first article sends article data having a default data item to the server 2 at a default sampling rate.

FIG. 8 is a flowchart showing details of the processing of the selection. In step S301, a variable n designating the number of first articles is initialized to “1”.

In step S302, the article selection part 214 calculates a data amount of the article data from the first article and the second article, and calculates a learning cost by inputting the data amount into a predetermined arithmetic expression, the article data being used as learning data in the case of n-first articles.

In step S303, the article selection part 214 determines whether the learning cost calculated in step S302 is higher than a reference cost. When the learning cost is equal to or lower than the reference learning cost (NO in step S303), the article selection part 214 increases the variable n by a predetermined number (e.g., “1”)(in step S304), and causes the processing to return to step S302. When the learning cost is equal to or higher than the reference learning cost (YES in step S303), the processing proceeds to step S305. As described heretofore, calculation of the learning cost is repeated while increasing the number of first articles until the learning cost becomes higher than the reference learning cost, and the maximum number of first articles is searched to allow the learning cost to be equal to or lower than the reference learning cost.

In step S305, the article selection part 214 calculates a proportion of the number of first articles to the total number of first articles and second articles in accordance with a current value of the variable n.

In step S306, the article selection part 214 reads out, from the article database 221, the article data of all the articles 1 stored in the article database 221, and calculates a selection score for each of the articles 1 on the basis of the read-out article data.

For instance, the selection score is calculated with the following equation:

Selection score=A1·(sending frequency of article data)+A2·(use frequency of battery 12)+A3·(discharge range of battery 12)+A4·(acquisition frequency of open circuit voltage of battery 12),
where each of the signs “A1” to “A4” denotes a weighting factor having a predetermined value.

From this perspective, the selection score has a larger value for an article 1 having each of a higher sending frequency of the article data, a higher use frequency of the battery 12, a wider discharge range of the battery 12, and a higher open circuit voltage of the battery 12.

In step S307, the article selection part 214 provides a higher rank to each article 1 having a higher selection score in descending selection score order.

In step S308, the article selection part 214 calculates a reference rank corresponding to the proportion calculated in step S305. For instance, there are 100 articles 1, and the proportion thereof denotes 0.1. In this case, the reference rank indicates “10”.

In step S309, the article selection part 214 selects an article 1 having the reference rank or higher as the first article. In Step S310, the article selection part 214 selects an article 1 having a rank lower than the reference rank as the second article. After finish of step S310, the processing proceeds to step S234 in FIG. 7.

Conclusively, the control data is updated only for the second article in the second embodiment. This enables acquisition of article data mainly from a first article having a high possibility of providing useful article data for machine learning, and attains a purpose machine learning model having a high accuracy.

This disclosure can adopt modifications described below.

(1) Although both the optimal data item and the optimal sampling rate are determined in the first and second embodiments, this disclosure is not limited thereto, and either the optimal data item or the optimal sampling rate may be determined.

(2) Although a selection reference value corresponds to a proportion of the first article to the first article and the second article in the second embodiment, this disclosure is not limited thereto. For instance, a predetermined selection score may be adopted for the selection reference value.

(3) Although the article selection part 214 calculates a learning cost by using a predetermined arithmetic expression in step S302 in FIG. 8, the disclosure is not limited thereto. The article selection part 214 may calculate the learning cost from a load factor of the CPU in actual execution of the machine learning using the article data. In this case, for instance, a predetermined load factor defining an upper limit value of the learning cost may be adoptable as a reference learning cost.

(4) The transmission part 213A does not transmit control data to the first article in the second embodiment, but may transmit control data for causing the first article to send article data having a specific number of default items at a default sampling rate. Consequently, even in case where the article 1 has, for example, an optimal data item and an optimal sampling rate each set in past, the data item is restorable to a default data item and the sampling rate is restorable to a default sampling rate.

(5) Although the purpose machine learning model is a model of outputting a state of a battery like an SOC in each of the first and second embodiments, this disclosure is not limited thereto. The model may be a model of determining damage to or deterioration of an electric appliance, or may be a model of analyzing a driving state of a driver of an vehicle. In generating the model of determining damage to or deterioration of the electric appliance as the purpose machine learning model, operational data of the electric appliance may be used as article data. In generating the model of analyzing the driving state of the driver as the purpose machine learning model, article data including, as data items, an acceleration rate of the vehicle, GPS information indicating a position of the vehicle, and an angular velocity of the vehicle may be adopted.

An information processing method according to the present disclosure is useful in the technical field of machine learning using article data collected from an article.

1. An information processing method for an information processing apparatus connected to one or more articles via a communication network, the information processing method comprising:
acquiring and storing article data in a memory, the article data including a predetermined data item and being sent from the one or more articles at a predetermined sampling rate;
calculating an accuracy of a machine learning model which performs machine learning by using the article data stored in the memory when a data amount of the article data stored in the memory is detected to reach a reference data amount or greater, and determining at least one of reduction in data item and reduction in sampling rate so that the calculated accuracy satisfies a reference accuracy; and
transmitting, to the one or more articles, control data for controlling the one or more articles to send the article data by using at least one of a data item after the reduction and a sampling rate after the reduction.

2. The information processing method according to claim 1, wherein the predetermined data item includes a plurality of data items, and,
in the determining, a priority rank of each of the data items is acquired, and one or more candidate data items are determined in descending priority order as remaining data items.

3. The information processing method according to claim 2, wherein,
in the determining, a minimum sampling rate at which the accuracy satisfies the reference accuracy is calculated as a candidate sampling rate for each of the candidate data items, one or more sets each including a candidate sampling rate and a candidate data item corresponding to the candidate sampling rate are generated, and the candidate sampling rate and the candidate data item included in a set having a minimum data amount among the sets are respectively determined as the sampling rate after the reduction and the data item after the reduction.

4. The information processing method according to claim 2, wherein the priority rank is calculated on the basis of importance of each of the data items calculated in the machine learning of the article data stored in the memory, the machine learning adopting a predetermined machine learning algorithm.

5. The information processing method according to claim 4, wherein the machine learning algorithm includes a random forest.

6. The information processing method according to claim 2, wherein each of the candidate data items includes one or more data items combined in the descending priority order.

7. The information processing method according to claim 1, further comprising:
selecting each of the articles as a first article satisfying a predetermined selection reference or as a second article dissatisfying the predetermined selection reference; and,
in the transmitting of the control data, transmitting the control data to the second article without transmitting the control data to the first article.

8. The information processing method according to claim 7, wherein,
in the selecting, a selection score is calculated for each of the articles on the basis of the article data stored in the memory, and an article having a selection score of a selection reference value or higher is selected as the first article.

9. The information processing method according to claim 8, wherein the selection reference value corresponds to a proportion of the first article to the first article and the second article,
the proportion being a maximum proportion to allow a learning cost to be a reference learning cost or lower in the machine learning of the article data sent from the first article and the second article.

10. The information processing method according to claim 8, wherein the selection score has a value corresponding to a sending frequency of the article data.

11. The information processing method according to claim 8, wherein the article includes a battery, and
the selection score has a value corresponding to at least one of a sending frequency of the article data, a use frequency of the battery, a discharge range of the battery, and an acquisition frequency of an open circuit voltage of the battery.

12. The information processing method according to claim 1, wherein the article data includes data about the battery included in the article.

13. An information processing apparatus connected to one or more articles via a communication network, the information processing apparatus comprising:
an acquisition part that acquires and stores article data in a memory, the article data including a predetermined data item and being sent from the one or more articles at a predetermined sampling rate;
a determination part that calculates an accuracy of a machine learning model which performs machine learning by using the article data stored in the memory when a data amount of the article data stored in the memory is detected to reach a reference data amount or greater, and determines at least one of reduction in data item and reduction in sampling rate so that the calculated accuracy satisfies reference accuracy; and
a transmission part that transmits, to the one or more articles, control data for controlling the one or more articles to send the article data by using at least one of a data item after the reduction and a sampling rate after the reduction.

14. A non-transitory computer readable recording medium storing an information processing program for causing a computer to serve as an information processing apparatus connected to one or more articles via a communication network, the information processing program comprising:
causing a processor included in the information processing apparatus to execute:
acquiring and storing article data in a memory, the article data including a predetermined data item and being sent from the one or more articles at a predetermined sampling rate;
calculating an accuracy of a machine learning model which performs machine learning by using the article data stored in the memory when a data amount of the article data stored in the memory is detected to reach a reference data amount or greater, and determining at least one of reduction in data item and reduction in sampling rate so that the calculated accuracy satisfies a reference accuracy; and
transmitting, to the one or more articles, control data for controlling the one or more articles to send the article data by using at least one of a data item after the reduction and a sampling rate after the reduction.
